(19) United States
(12) Patent Application Publication
(10) Pub. No.: US 2005/0160183 A1
(43) Pub. Date: Jul. 21, 2005

(54) Tunnel broker management

(75) Inventors: Mohammed Valli, Ipswich (GB); Aris Petridis, London (GB); Stuart M Prevost, Ipswich (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company, London (GB)

(21) Appl. No.: 10/508,031

(22) PCT Filed: Mar. 18, 2003
(86) PCT No.: PCT/GB03/01138

(30) Foreign Application Priority Data
Mar. 27, 2002 (GB) 0207231.2
Jun. 21, 2002 (GB) 0214399.8

(51) Int. Cl. G06F 15/16

(52) U.S. Cl. 709/245

(57) ABSTRACT

A tunnel broker (4) configures a first node (2), which supports first and second communications protocols, e.g. IPv4 and IPv6, to communicate with a second node which supports IPv6, over an IPv4 network. The tunnel broker (4) assigns a unique IPv6 address (10) to the node, generated using a combination of the IPv4 address (11) of the node and a counter value (13). The counter is incremented for each user sharing an IPv4 address (11), so that each user sharing an IPv4 address (11) is allocated a unique IPv6 address (10). The tunnel broker service is restricted to users who have created an account. An account password is sent to the user's e-mail address, ensuring that a person giving a false address cannot gain access. A user cannot create further accounts using the same e-mail address. The number of tunnels that can be configured using each account is limited. These measures act to prevent an individual configuring a large numbers of tunnels (1) in a denial of service attack.

The invention relates to facilitating communication between hosts via a network such as the Internet. Particularly, but not exclusively, the invention relates to a method of tunnel broker management and a tunnel broker for allowing nodes that support one protocol, to communicate via a network that supports a different protocol.

Communication over a network such as the Internet is governed by a set of rules, or protocols, which allow information to be divided into packets, sent through the network via one or more routes and reassembled at their destination. At the present time, the most widely used protocol is Internet Protocol version 4 (IPv4). An IPv4 packet header includes the address of the device sending the information and its destination, where each address is expressed using 32 bits in the form of four 8-bit numbers, or octets, e.g. 213.38.220.226. However, this format accommodates only a limited number of addresses. Use of the Internet has increased sharply in recent years and it is expected that growth will continue, due to an increase in the number of users and the greater range of devices, such as personal computers and mobile phones, which make use of the Internet. This is likely to lead to a shortage of IPv4 addresses.

A newer version of the above protocol, Internet Protocol version 6 (IPv6), is described in Request for Comments RFC 2460, The Internet Society, December 1998. IPv6 overcomes this problem by providing a larger address space in its headers. An IPv6 address uses 128 bits in the form of 16 octets, greatly increasing the number of available addresses. However, it is not feasible for all the devices and networks connected to the Internet to migrate to IPv6 at once. The changeover between the two protocols is a gradual ongoing process as new devices and applications supporting the new protocol become available and individual hosts and networks begin to use IPv6. There will be a long period of transition during which both protocols will coexist. This will require inter-operability measures to meet the demands of IPv6 users needing to send data over networks configured using IPv4.

One method of addressing this problem is “tunnelling”, which allows users with an IPv4 connection to gain access to an IPv6 network. The user has a dual-stack node, i.e., a host or router that supports both protocols, referred to hereafter as an end user node. A tunnel is created between the end user node and the IPv6 network by encapsulating IPv6 packets within an IPv4 datagram, so that they can be sent to their destination over an IPv4 network. Until recently, the small number of tunnels in use were manually configured and maintained, resulting in a heavy management load on network administrators. This will increase further as greater numbers migrate to IPv6.

This problem is being addressed by the provision of dedicated servers, which automates the management for creation and maintenance of tunnels, known as tunnel brokers. A tunnel broker is described in the Request for Comments RFC 3053, The Internet Society, January 2001, where the tunnel broker creates, modifies and deletes tunnels in response to requests from a user. The tunnel broker configures the remote end of the tunnel and sends information for configuring the user's tunnel end point to the user's node.

The tunnel brokers presently in use tend to cater for small numbers of users. However, particular problems may arise when accommodating dynamic IP users who do not retain the same IPv4 address each time they connect to the network.

According to one aspect of the invention, there is provided a method of configuring a first node, which supports first and second communications protocols, to communicate with a second node, which supports the second protocol, over a communications network which operates according to the first protocol, wherein the first node is associated with a first address for use with communications which conform to the first protocol, the method including the steps of receiving a request for allocation of a second address for use by the first node for communications which conform to the second protocol, in response to the request, generating a value, combining the value with the information relating to a user of the first node to generate a unique second address and allocating the second address to the first node.

For example, there may be situations where an IPv4 address may be associated with more than one user, for example where a network is accessed via an Internet service provider. Many Internet service providers assign an IPv4 address to a user from a pool of addresses each time they connect to the network, and so, over a period of time, a particular IPv4 address might be assigned to a number of different users. As the configuration of any tunnels necessarily includes the tunnel end point address, the allocation of a single IPv6 tunnel end point address to each given IPv4 address would result in tunnels being shared between users. This is avoided by giving each user a unique IPv6 tunnel end point address, in a method that is suitable for both dynamic and static IP users.

In a preferred embodiment of the present invention, requests for allocation of a second address are accepted only from those users who have created an account, where the creation of said account requires the completion of a registration process in which the user supplies a current address, and wherein the creation of further accounts by a user supplying the same address is prevented.

It is possible that users may seek to misuse or abuse an automated system by creating an excessive number of tunnels. As tunnel servers (the second node) have finite resources, this activity may eventually bring about a denial of service. A person intending to initiate a denial-of-service attack would have to create multiple accounts. To prevent this, the accounts created by the user are associated with their e-mail address and the tunnel broker prohibits the creation of multiple accounts using a single e-mail address. It is also preferable for the method to include sending an account password to the e-mail address provided by the user, thereby preventing a person registering a false e-mail address from gaining access to the tunnel broker. In a further preferred embodiment of the present invention, the method further comprises:
evaluating the performance of a plurality of available nodes; and
using the results of the evaluation to select a second node from the plurality of available nodes.

According to the invention, there is also provided a tunnel broker for configuring a first node, which supports first and second communications protocols, to communicate with a second node, which supports the second protocol, over a communications network which operates according to the first protocol, wherein the first node is associated with a first address for use with communications which conform to the first protocol, comprising means for receiving a request for the allocation of a second address for use by the first node for communications which conform to the second protocol, means for receiving information relating to a user of the first node, means for generating a value in response to the request, means for combining the value with the information relating to the user to generate a unique second address and means for assigning the second address to the first node.

Preferably, an interface is provided so that the user may submit a request for the tunnel broker to configure a tunnel, and for the user to monitor their tunnel, for example via a web page. Allowing the user to configure a tunnel and then to monitor it reduces the need for manual intervention by the network administrator.

In a preferred embodiment, the tunnel broker also comprises means for synchronising the configuration of a second node with the configuration stored by the tunnel broker, the synchronising means being arranged:
to compare the configurations stored on the tunnel broker with configuration information stored on the second node;
to determine which configurations are stored on only one of the tunnel broker and second node; and
where a configuration is stored on the tunnel broker and not the second node, to copy the configuration stored on the tunnel broker to the second node.

According to a second aspect of the invention, an address structure for use in a system that facilitates communications between a first node, which supports first and second communications protocols, with a second node which supports the second protocol, over a communications network which operates according to the first protocol, wherein the first node is associated with a first address for use with communications which conform to the first protocol, comprises a first portion corresponding to the first address and a second portion corresponding to a value, wherein the combination of the first and second portions is unique.

Embodiments of the invention will now be described by way of example with reference to the accompanying drawings, in which:

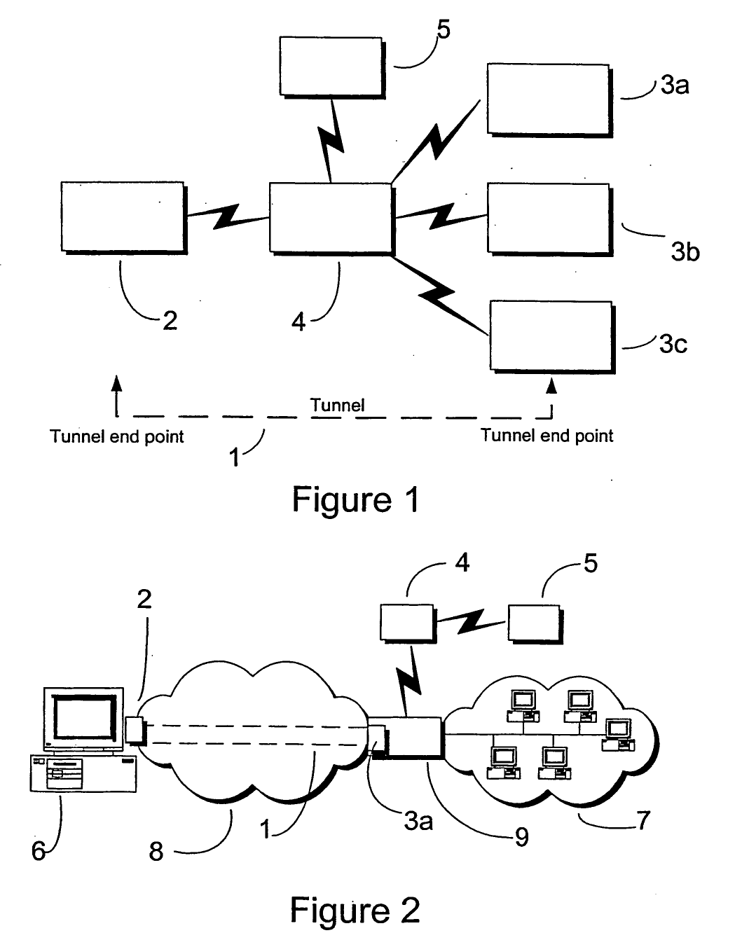

FIG. 1 shows the functional elements which make up the tunnel broker model set out in RFC 3053,

FIG. 2 is a schematic diagram illustrating a tunnel broker system according to the invention,

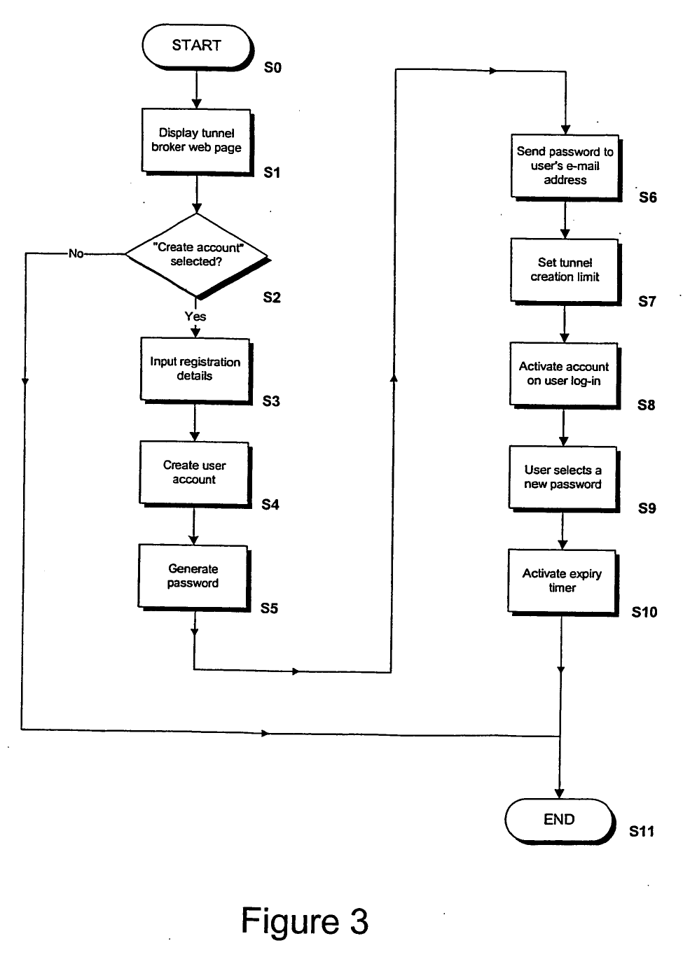

FIG. 3 is a flowchart showing how a user creates an account on the tunnel broker,

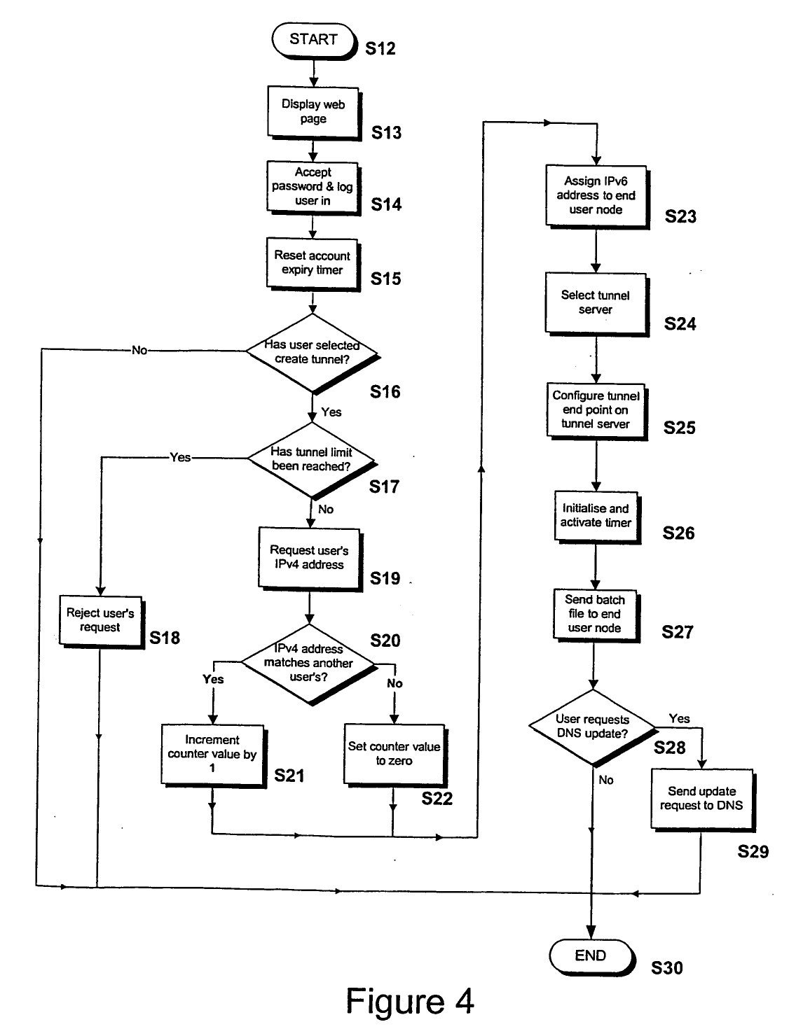

FIG. 4 is a flowchart showing how a user creates a tunnel via the tunnel broker,

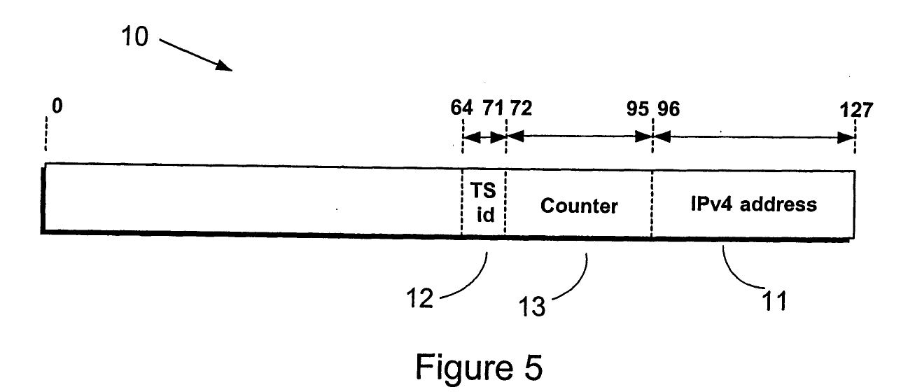

FIG. 5 depicts an IPv6 tunnel end point address assigned to a node,

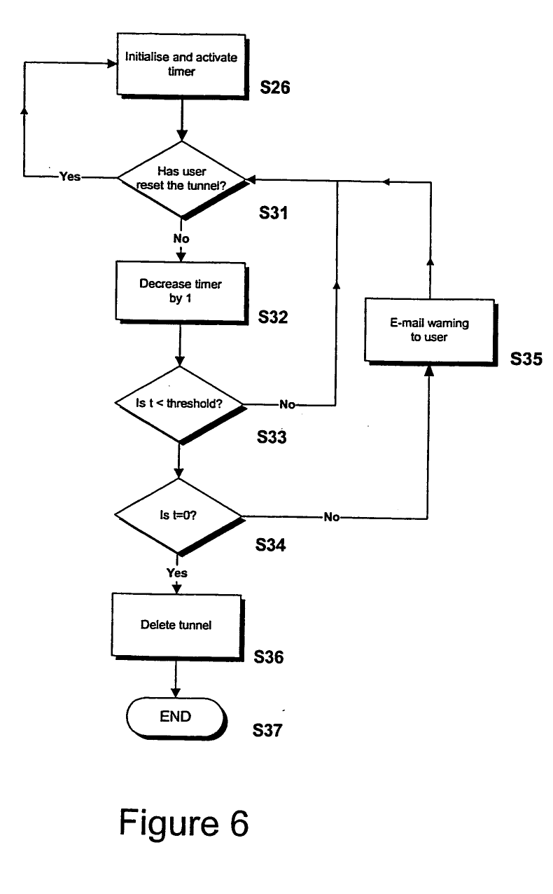

FIG. 6 is a flowchart showing the association of an expiry period with a tunnel created by the user,

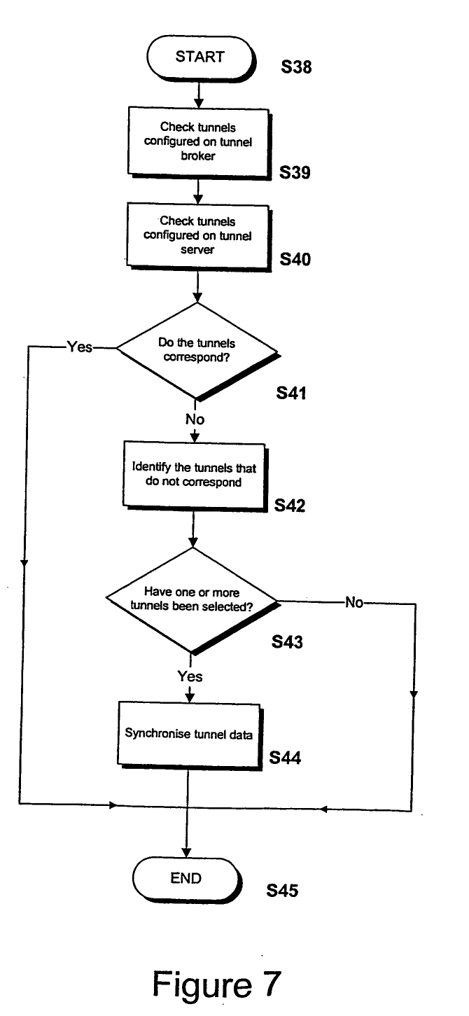

FIG. 7 is a flowchart depicting the synchronisation of the tunnel broker and tunnel server.

FIG. 1 shows the tunnel broker model set out in RFC 3053 referred to above. A tunnel 1 is created between two tunnel end points, an end user node 2 and one of a number of tunnel servers 3a-c. The end user node comprises a dual-stack host or router, which is capable of handling data encoded according to either of the IPv4 and IPv6 protocols. The tunnel is configured by a tunnel broker 4, which comprises an application program running on a dedicated server machine. The tunnel server 3a-c comprises a dual stack router connected, for example, to the Internet.

The model includes a Domain Name Server (DNS) 5. Although IP addresses are expressed as a series of numbers, most addresses also have domain names associated with them, where the address is specified by a series of words, for example, ‘www.bt.com’, which users tend to prefer. A DNS 5 maintains a look-up table of domain names and IP addresses. When a user enters a domain name, a request is sent to one or more domain name servers and the corresponding IP address is retrieved, a process referred to as forward look-up. A further process known as reverse-lookup is also used to map IP addresses to names and a number of applications use this procedure to verify the origin of a user before allowing access to their services.

FIG. 2 depicts a system for connecting an end user node 6 having an IPv4 Internet connection, to an IPv6 network 7 via an IPv4 network 8, for example the Internet, under the control of a tunnel broker 4. The end user node 6 includes a dual stack node 2, which is implemented as part of the operating system, as currently supported by most major operating systems. The system allows the end user node 6 to communicate with an IPv6 Internet Service Provider (ISP) 9, which includes a tunnel server 3a, via the IPv4 network 8 over the tunnel 1. Data packets created at the end user node 6 intended for the IPv6 network 7 and including address information in the header, are encapsulated in an IPv4 datagram. The data is transmitted via the IPv4 configured network 8 to the ISP 9, where the data is un-encapsulated by the tunnel server 3a and then transmitted onto the IPv6 network 7.

A user of the end user node 6 can request the creation of a tunnel 1 by the tunnel broker 4 via a web-based user interface. However, they must first register with the tunnel broker service. Referring to FIG. 3, beginning at step s0, a web page is displayed to the user (step s1) who selects an option to create an account (step s2). The user then submits registration details (step s3), including their e-mail address.

An account is then created on the tunnel broker 4, which is associated with the user's e-mail address (step s4). The tunnel broker randomly generates a password for use by the user for access to their account on the tunnel broker (step s5). The password is sent to the e-mail address that they have provided (step s6). This prevents a person who registers under a false e-mail address gaining access to the tunnel broker.

The tunnel broker also assigns a limit to the number of tunnels that can be created in each account (step s7). The tunnel broker is configured to prevent the creation of multiple accounts using a single e-mail address, so that the combination of these measures prevents end users from repeatedly creating tunnels. The creation of a large number of tunnels, malicious or otherwise, would occupy valuable resources on the tunnel server and could result in a denial of service.

Once an account has been created, the user activates their account by logging onto the service using the password (step s8). Once their account is activated, they may change the password to one of their own choice (step s9).

Finally, an expiry date is associated with the account so that an account is deleted if the user does not log in for an extended period of time, e.g. three months. A timer is set when the account is first activated (step s10) and proceeds to count down until a threshold is reached. The timer is reset whenever the user logs in to their account.

The account creation process is then complete (step s11). The user can now create and configure tunnels, as shown in FIG. 4. Starting at step s12, the user visits the tunnel broker web page (step s13) and logs in using his password (step s14). As mentioned above, the account expiry timer is reset when the user logs in (step s15). The user then selects an option to create a tunnel (step s16). The number of tunnels that can be created by a user is limited, and the tunnel broker checks whether the quota associated with the user's account has been filled (step s17). If it has, the user's request is rejected (step s18).

If the user's request is accepted, the tunnel broker 4 requests the IPv4 address of the end user node 6 (step s19). The tunnel broker 4 maintains a database of IPv4 addresses submitted by registered users of the service. The dual stack node IPv4 address is checked against the addresses stored in the database, to determine whether it matches one previously submitted by another registered user (step s20). The tunnel broker 4 maintains counters associated with each registered IPv4 address. The value of a particular counter is incremented each time a different user with the same IPv4 address requests a tunnel (step s21), i.e., if the IPv4 address is already listed in the database. Alternatively, the counter value could be decremented for each user with the same IPv4 address. Otherwise, the counter is set to an initial value, for example, zero (step s22).

The combination of the counter value and the IPv4 address is unique for each user. The tunnel broker uses this combination to form part of a unique IPv6 tunnel end point address, which it assigns to the end user node 6 (step s23). Referring to FIG. 5, the IPv6 address 10 comprises 128 bits. The last 32 bits 11 correspond to the host's IPv4 address. An 8-bit tunnel server number 12 indicates which server the tunnel is configured on, for use where a single tunnel broker 4 is managing more than one tunnel server 3a-c. The tunnel server number 12 is, for example, a number between 0 and 255. The IPv6 tunnel end point address 10 includes the counter value, in the form of a 24-bit number 13. A 24-bit counter value allows 2²⁴ users to share a single IPv4 address while ensuring that the last 64 bits of the IPv6 address assigned to each user is unique.

Although this particular embodiment uses an IPv4 address and a counter to identify a particular user, any combination of information uniquely identifying an individual users could be used. For example, personal information, such as a date of birth, relating to a user could be encoded and used in place of the IPv4 address. Furthermore, the counter could be replaced with another number such as their room number, their telephone extension number, a randomly generated number or, where the same value has not been used in place of the IPv4 address, their date of birth. However, the use of a counter ensures that each address assigned by the tunnel broker is different, so it is not necessary to check whether the complete address matches one assigned to another node. Furthermore, when combined with an IPv4 address, a counter value 13 results in the tunnel end point addresses associated with a given IPv4 address being kept together in consecutive address blocks, minimising routing complexity.

As mentioned above, a tunnel broker 4 can manage multiple tunnel servers 3a-c. For example, a company using the tunnel broker service may have a number of sites that are separated geographically, so it may be convenient to provide a local tunnel server for each location, or an increased capacity may be required. Referring again to FIG. 4, the tunnel broker 4 performs tests to determine which of the tunnel servers 3a-c the new tunnel 1 should be configured on (step s24). Several factors may be taken into consideration. The tunnel broker 4 submits instructions to each tunnel server 3a-c to execute a command. The host 6 measures the performance of each of the tunnel servers 3a-c and return the results to the tunnel broker 4 for determining which server is most suitable. The performance can be evaluated in terms of delay, e.g. using ping, throughput or number of hops taken, for example, using traceroute. The decision can also be based on a comparison of the loads on each server, and by taking into account the interests of the user as defined in their service level agreement.

Having made a selection, the tunnel broker 4 configures one end point of the tunnel on the selected tunnel server 3a (step s25) before initialising and activating an associated timer (step 26), the function of which will be explained in detail below. The tunnel broker 4 then sends an email to the user containing the end user node configuration script, which configures the tunnel end point at the dual stack node 2 (step s27). Alternatively, the tunnel broker 4 may send a request to the user, asking them to download the configuration script via the user interface web page. Running the script sets up a routing table to tunnel all IPv6 traffic from the end user node 6 to the tunnel server 3a. The tunnel is considered activated when both end points have been configured.

Once the tunnel has been activated, the user may also associate a name with the tunnel end point, by selecting an option on the user interface web page (step s28). The tunnel broker then sends a request to update the Domain Name Server (DNS) 5 (step s29). The tunnel creation process is then complete (step s30).

An administration interface is also provided, in the form of a web page, for use by a network administrator with responsibility for the tunnel broker service. By using the administration interface, the administrator can monitor the creation of accounts and tunnels, view lists and statistics of tunnels and accounts, maintain the service and respond to user requests, e.g., by adjusting the tunnel creation limit for a user account. The administrator may also select options presented on the administration interface to prohibit access to the service from certain IPv4 addresses or disable tunnels and accounts.

Where a tunnel broker 4 manages multiple tunnel servers 3a-c, as described above, a share of the available address space must be allocated to each of the tunnel servers 3a-c. It is preferable for each tunnel server to be assigned a single large address block, rather than a number of smaller blocks, to minimise routing complexity.

In the following example, the notation /x will be used to denote the number of bits that have been predefined. For example, a /40 address block indicates addresses where 40 bits have been predefined but the remaining bits are available for use, e.g. for allocating different addresses to hosts. The notation y /x denotes y address blocks where x bits have been predefined, so that the term 4 /40 address blocks refers to 4 address blocks, each of which have 40 predefined bits.

A tunnel broker 4 is assigned single or multiple /40 address blocks, i.e. a number of addresses that may be allocated to users. These addresses will be allocated to users in the form of /128 tunnel end point addresses, /64 subnet address blocks and /48 network address blocks. Each tunnel server 3a-3c may be assigned one of these /40 address blocks. Therefore, a single tunnel server 3a in this example could then allocate up to 65535 /64 address blocks and 255 /48 address blocks, although the relative proportions of /64 and /48 address blocks may differ between the tunnel servers 3a-c.

The tunnel broker 4 monitors the number of /48 address blocks allocated for the creation of smaller /64 address blocks on a per tunnel basis. If a need for further /64 address blocks arises, the tunnel broker 4 selects a /48 address block for use in assigning /64 addresses. If no further address blocks are available on a tunnel server 3a, the tunnel broker 4 may assign it another /40 address block.

A user may also be allocated one or more /64 or /48 address blocks, selected from a pool of available addresses. The /64 or /48 address blocks are not bound to the configured tunnels as the configuration of the address block allocation on the end user node is independent of the /128 tunnel endpoint configuration.

The tunnel broker 4 allows end users to migrate their old /64 and /48 address block allocations and bind them to new /128 endpoint addresses. For example, there may be situations in which a user changes their IPv4 address. The tunnel broker 4 is flexible enough to allow any /64 or /48 address blocks assigned to that user to migrate to the new IPv4 address and be bound to new /128 end point addresses 10.

The user may submit a request to the tunnel broker 4 for the assignment of a /48 address block. However, it is not desirable for such an allocation to be made automatically. Instead of meeting this request immediately, the tunnel broker 4 appends it to an “Awaiting Authorisation” queue and notifies the network administrator with responsibility for the tunnel broker 4, e.g., by e-mail or SMS. The queue is presented to the network administrator via the administration interface, along with any necessary end-user information. The network administrator may elect to contact the end-user, or carry out other checks, before permitting the assignment.

The user may request the right to manage the reverse lookup zone that corresponds to their allocated address space by selecting an option on the user interface web page. The user can then submit the names of one or two Domain Name Servers that will manage the reverse zone. The names of the Domain Name Servers submitted by the user are sent to the Domain Name Server 5.

There is a risk that a significant proportion of the memory may be occupied by tunnel configurations and accounts that, for one reason or another, are no longer in use. For example, a user may have registered for the purpose of testing the service and may not wish to continue using it. It is desirable to minimise the number of obsolete tunnels and accounts configured on the tunnel broker and tunnel servers, as these occupy the resources in terms of memory and available addresses. A limited lifespan is defined for each tunnel, e.g. 20 days. As mentioned in relation to FIG. 4 above, a timer is set to this value and activated to count down accordingly (step s26).

Referring to FIG. 6, after the timer has been set (step s26), the tunnel broker 4 determines whether the user has reset the tunnel (step s31). The reset facility can be provided via the user interface web page. If the user has reset the tunnel, the timer is reset to its initial value and the countdown is restarted (step s26).

If the user has not reset the tunnel, the timer value is decreased by one for each day that has elapsed (step s32). When the countdown reaches a threshold value, for example 3 days, but has not expired (steps s33, s34), an e-mail is sent to the user (step s35) inviting them to reset the tunnel activation and warning them that failure to do so within the remaining time will result in the tunnel being deleted. If the user does not do this, reminder e-mails will be sent on a daily basis until the timer reaches zero. If the timer reaches zero (step s34), the tunnel is deleted (step s36) and the process ends (step s37).

A similar procedure can be used for the account expiry timer in FIG. 3 (step s10), where the user is sent daily warnings by e-mail when the countdown drops below a predetermined threshold and unused accounts deleted when the countdown reaches zero. These measures ensure that the tunnel server maintains only those tunnels and accounts that are in use. The user's /128 tunnel end point addresses and any allocated /64 or /48 address blocks are maintained for a short period, e.g., 1 month, after the deletion of their account, for use should the user wish to reactivate their account. After this period, the addresses are returned to the pool of available address blocks.

The administrator can disable either or both of the timer functions for a selected tunnel and/or account via the administration interface.

Another situation that may produce obsolete tunnels for the duration of the tunnel countdown arises where a user changes their IPv4 address. As the IPv6 tunnel end point address 10 contains the user's IPv4 host address, a dynamic IP user, or a particular user who has changed their IPv4 address, is assigned a different IPv6 tunnel end point address by the broker 4 each time a change occurs.

The tunnel broker 4 supports a facility that allows the user to request that the configuration of one or more pre-existing tunnels is copied and modified for use with their new IPv6 tunnel end point address 10. The tunnel broker 4 creates a new tunnel with the same specification as the previous tunnel, but associated with the user's new IPv6 tunnel end point address 10, and deletes the original one. The tunnel configuration also includes a flag to indicate whether the user has a dynamic or static IPv4 address, so that the configuration of a new tunnel and deletion of a previous tunnel can be performed automatically when a dynamic IP user logs into their account.

The tunnel broker and tunnel server resources may also be occupied by obsolete accounts and tunnels where a user has changed their e-mail address. This may arise, for example, where a user changes Internet service provider and is assigned a new e-mail address. The user's account and, therefore, the tunnels they have configured, are associated with their previous e-mail address. The user is allowed to modify the e-mail address associated with their account and continue using the tunnels that they have created.

A user wishing to change the e-mail address associated with their account logs in and submits their new e-mail address via the user interface web page. The tunnel broker will then generate a random password which is sent to the new e-mail address. The user must then use this password to gain access to their account. If such a measure is not present, a user could change their registered e-mail address to a false one and then create a new account using their genuine e-mail address. This would circumvent the measures for preventing denial-of-service attacks.

The tunnel server configurations are backed up on a non-volatile medium whenever a new tunnel is created so that, in the event of a failure, the tunnels could be restored. Restoration may be necessary, for example, following corruption of the tunnel server memory, or following replacement of the tunnel server 3a. However, the tunnel server 3a may not allow the configuration to be saved and restored in this way, so an automatic synchronisation method is provided on the tunnel broker 4.

The method of synchronisation is described with reference to the flowchart of FIG. 7, beginning at step s38. Firstly, the tunnel broker 4 checks which tunnels it has configured (step s39) and then ascertains which tunnels are maintained on the tunnel server (step s40). The tunnel broker then determines if the two sets of tunnel data correspond with each other (step s41) and identifies any tunnels that exist on the tunnel broker but not on the tunnel server and vice versa (step s42). The network administrator can then select one or more tunnels that are missing from either the broker or the server for synchronisation. Alternatively, the network administrator can select all tunnels, in which case all the tunnels configured between the broker and server will be automatically synchronised. The tunnel broker 4 determines which tunnels have been selected by the administrator (step s43) and synchronises them by copying the relevant tunnel data from the broker to the server, or vice versa (step s44), thereby completing the process (step s45).

However, it is possible that tunnels may be configured on the tunnel server 3a that were not created or are not maintained by the tunnel broker 4. The tunnel broker 4 can compile a list of tunnels falling into this category, which can be inspected via the administration interface. An administrator may then select tunnels from this list for deletion or, alternatively, associate the tunnels with an account on the tunnel broker 4.

The specification of each of the tunnels managed by the broker is also saved onto a non-volatile storage medium periodically to maintain an up-to-date router configuration.

The user can access statistical information for monitoring the performance of their tunnel. The results are presented to the user in a suitable format, e.g., as raw data or arranged into tables and graphs that may be viewed on a web page. The tunnel broker 4 can be configured to collect data and perform analyses, such as trending, automatically at regular intervals for presentation to the user.

The tunnel broker 4 also compiles administration statistics, such as the number of tunnels created in a given time period, new registrations, number of re-activated tunnels, numbers of expired tunnels so that these are readily available to the network administrator. The administration interface includes menu options allowing the administrator to request the statistics for individual accounts and tunnels, such most recent access or number of packets sent and to view the trends on an hourly, daily or monthly basis. The data may indicate misuse of the system, e.g., by a user sending a high volume of traffic through a tunnel in an attempt to bring about a denial of service. The administrator can use the statistics to identify the user and suspend access to their tunnel and/or account.

The statistical data can be stored at regular intervals to allow analysis of long term trends. For example, if the data reveals a sharp drop in the number of newly created tunnels, the service provider may conclude that a competing provider has created a better, or cheaper service, or that consumer awareness of his own service is low, providing indications on how the service or its marketing could be improved.

1. A method of configuring a first node, which supports first and second communications protocols, to communicate with a second node, which supports the second protocol, over a communications network which operates according to the first protocol, wherein the first node is associated with a first address for use with communications which conform to the first protocol, the method including the steps of: receiving a request for allocation of a second address for use by the first node for communications which conform to the second protocol; in response to the request, generating a value ; combining the value with information relating to a user of the first node to generate a unique second address; and allocating the second address to the first node.

2. A method according to claim 1, wherein the information relating to the user is the first address.

3. A method according to claim 1, wherein the step of generating a value comprises incrementing or decrementing a value generated in response to a previous request.

4. A method according to claim 1, wherein the step of generating a value comprises encoding an item of personal information relating to the user.

5. A method according to claim 1, wherein the step of generating a value comprises generating a random number.

6. A method according to claim 1, wherein each node has a plurality of users and an associated first protocol address for use with communications that conform to the first protocol and the value is unique for each user sharing the same first protocol address.

7. A method according to claim 1, wherein the step of combining the value and the information relating to the user to generate the unique address further comprises including a number identifying the second node in the unique address.

8. A computer program which, when executed by a processor, performs the method of claim 1.

9. A tunnel broker for configuring a first node, which supports first and second communications protocols, to communicate with a second node which supports the second protocol, over a communications network which operates according to the first protocol, wherein the first node is associated with a first address for use with communications which conform to the first protocol, comprising: means for receiving a request for allocation of a second address for use by the first node for communications which conform to the second protocol ; means for receiving information relating to a user of the first node; means for generating a value in response to the request; means for combining the value with the information relating to the user to generate a unique second address; and means for assigning the second address to the first node.

10. A tunnel broker according to claim 9, wherein the information relating to the user comprises the first address.

11. A tunnel broker according to claim 9, wherein the generating means is a counter, which increments or decrements a value generated in response to a previous request.

12. A tunnel broker according to claim 9, wherein the generating means comprises means for encoding an item of personal information relating to the user.

13. A tunnel broker according to claim 9, wherein the generating means comprises means for generating a random number.

14. A tunnel broker according to claim 9, wherein the value is unique for each one of a plurality of users of the first node, where the first node has a first protocol address for use with communications conforming to the first protocol and the users share the same first protocol address.

15. A tunnel broker according to claim 8, wherein the means for combining the value with the information relating to the user also includes a number identifying the second node in the unique second protocol address.

16. A tunnel broker according to claim 9 wherein the first protocol is Internet Protocol version 4.

17. A tunnel broker according to claim 9, wherein the second protocol is Interne Protocol version 6.

18. A tunnel broker according to claim 17, further comprising means for configuring the second node to communicate with the first node.

19. A tunnel broker according to claim 18, further comprising means for storing the configuration of the second node and means for synchronising the configuration of the second node with the stored configuration.

20. A tunnel broker according to claim 9, further comprising means for including in the configurations of the second node an attribute that indicates whether a first protocol address associated with the first node for use with communications conforming to the first protocol is static or assigned dynamically.

21. A tunnel broker according to claim 20, further comprising means for automatically reconfiguring the first and second nodes in response to a change in the first protocol address, where the attribute indicates that the first protocol address is dynamically assigned to the first node.

22. An address structure for use in a system that facilitates communications between a first node, which supports first and second communications protocols, with a second node, which supports the second protocol, over a communications network which operates according to the first protocol, wherein the first node is associated with a first address for use with communications which conform to the first protocol, comprising a first portion corresponding to the first address and a second portion corresponding to a value, wherein the combination of the first and second portions is unique.

23. An address structure according to claim 22, wherein the value is provided by a counter.

24. An address structure according to claim 22, further comprising a number identifying the second node.

25. A method according to claim 1, wherein requests for allocation of a second address are accepted only from those users who have created an account, where the creation of said account requires the completion of a registration process in which the user supplies a current address, and wherein the creation of further accounts by a user supplying the same address is prevented.

26. A method according to claim 25, further comprising associating said second address allocated in response to a request with the respective user's account and limiting the number of said second addresses that can be associated with each account.

27. A method according to claim 25, further comprising generating a password and sending the password to the current address supplied by the user.

28. A method according to claim 1, further comprising: evaluating the performance of a plurality of available nodes; and using the results of the evaluation to select a second node from the plurality of available nodes.

29. A method according to claim 28 further comprising: configuring the second node to communicate with the first node; and providing a command script which, when run on the first node, configures the first node to communicate with the selected node.

30. A method according to claim 28, wherein the performance is evaluated using one or more of the following parameters: hop count, load, throughput or delay.

31. A method according to claim 28, wherein the selection of the second node is also based on a service level agreement.

32. A tunnel broker according to claim 19, wherein said means for synchronising the configuration of a second node with the stored configuration are arranged: to compare the configurations stored on the tunnel broker with configuration information stored on the second node; to determine which configurations are stored on only one of the tunnel broker and second node; and where a configuration is stored on the tunnel broker and not the second node, to copy the configuration stored on the tunnel broker to the second node.

33. A method according to claim 32, wherein, where a configuration is stored on the second node and not the tunnel broker, said means for synchronising are arranged to copy the configuration stored on the second node to the tunnel broker.
